(19) United States
(12) Patent Application Publication
(10) Pub. No.: US 2010/0226213 A1
(43) Pub. Date: Sep. 9, 2010

(54) User Customizable Timepiece

(76) Inventor: Brian Robert Drugge, Los Gatos, CA (US)

Correspondence Address: STEVEN A. NIELSEN;ALLMAN & NIELSEN, P.C., 100 Larkspur Landing Circle, Suite 212, LARKSPUR, CA, 94939, US

(21) Appl. No.: 12/717,715

(22) Filed: Mar. 4, 2010

Related U.S. Application Data
(60) Provisional application No. 61/157,334, filed on Mar. 4, 2009.

(51) Int. Cl. G04B 47/06; G04B 19/26

(52) U.S. Cl. 368/14; 368/15

(57) ABSTRACT

A timepiece or wristwatch displays celestial “complications” and meteorological events based upon calculations and conditions relevant to the geographic location of the timepiece. A memory storage device, microprocessor, mechanical and software controlled graphical display systems and network connectivity facilitate the input of user selected complications, display options, geographic arguments and other variables. The timepiece is not limited to a preprogramed geographic area or to predefined complications.

### RELATED PATENT APPLICATION AND INCORPORATION BY REFERENCE

This is a utility application based upon U.S. patent application Ser. No. 61/157,334 “Means and Methods of Delivery of Dynamic Content to Personal Items” filed on Mar. 4, 2009. This related application is incorporated herein by reference and made a part of this application. If any conflict arises between the disclosure of the invention in this utility application and that in the related provisional application, the disclosure in this utility application shall govern. Moreover, the inventor(s) incorporate herein by reference any and all patents, patent applications, and other documents hard copy or electronic, cited or referred to in this application.

### BACKGROUND OF THE INVENTION

(1) Field of the Invention

The invention generally relates to timepieces or wrist watches. More particularly, the invention relates to timepieces with means of allowing users to set various complications or attributes.

(2) Description of the Related Art

U.S. Pat. No. 6,825,830 by Kanesake et al discloses a timepiece in communication with a radio and wherein the radio is in communication with a network. U.S. Pat. No. 5,721,713 by Bornand discloses a watch with means of showing the direction of predetermined locations selected from a plurality of locations. U.S. Pat. No. 7,230,883 by Marhic et al discloses a tide display watch that displays tide data for various ocean locations and times.

The known related art comprises electric or mechanical watches that present various events, with such events sometimes referred to as “complications.” Such complications or events may be celestial based events such as sunrise, sunset, moon phase, ocean tides, equations of time, or leap years. A shortfall in the related art includes a limitation of showing celestial events of the Northern or Southern hemispheres. A shortfall in the related art within mechanical watches includes physical limitations in the number of available calculations and the number of displays or display variables.

### BRIEF SUMMARY OF THE INVENTION

The present invention overcomes shortfalls in the related art by presenting an unobvious and unique combination, configuration and use of mechanical components, electrical components, wireless communication components and other physical components to construct a timepiece adaptable to a wide variety of user set attributes. The known related art fails to disclose, suggest or teach the use of a system allowing a timepiece user to choose and set a dynamic display of information tailored to the user's desired geographic location or other user defined criteria.

For example, the disclosed timepiece may include watch face with a computer program or software enabled graphical display. The timepiece or watch may be in communication with a network which in turn may be in communication with an interactive web interface. A user or other person may use the interactive web interface to enter data, choose complications or information of interest and have such preferences and features entered into the memory components of the timepiece. The present disclosure overcomes shortfalls in the art, as the disclosed timepiece is not limited in utility to display options or complications installed at the time of manufacture. Unlike the known related art, the present timepiece system allows a user to upload or download desired complications or variables from an interactive user interface.

In one embodiment, the disclosed timepiece comprises a storage apparatus that retains celestial complications and other graphical and textual information for display. The timepiece may be set to a user's geographical location and thus accurately render geographical dependent complications and other content.

In one embodiment, the disclosed timepiece comprises a microprocessor or other computer with means of executing celestial and other time and location based calculations. Graphical or other representations of the completed calculations may be updated on a periodic basis and displayed upon the face of the timepiece. The timepiece may also be comprised of a physical clock hands in addition to a display screen.

### BRIEF DESCRIPTION OF THE DRAWINGS

FIG. 1 is a plan view of a disclosed timepiece device showing a watch face and a celestial and meteorological event display area.

FIG. 2 is plan view of a disclosed timepiece device displaying two celestial events.

FIG. 3 is a schematic view of various internal components comprising an embodiment of the disclosed timepiece.

FIG. 4 is a schematic view of a disclosed timepiece device with an integrated magnetic connector for recharging of the timepiece battery device.

FIG. 5 is a perspective view of a docking and recharging station compatible with a disclosed timepiece device.

FIG. 6 is a schematic view of a system of loading selected celestial or meteorological events or other user selected event data into a disclosed timepiece.

### REFERENCE NUMERALS IN THE DRAWINGS

100 graphic display area
110 traditional timepiece area
200 timepiece showing a Perseids meteor shower and other events
210 graphical representation of a moon phase
220 graphical display of a Perseids meteor shower
300 timepiece shown in a component view
310 memory storage device
320 GPS module
330 wireless communication module
340 microprocessor
400 timepiece shown with a magnetic connector 410
410 magnetic connector
420 rechargeable battery
500 docking recharging station
510 connector area for connection to the magnetic connector 410
600 timepiece in connection with a personal computer 610
610 personal computing device
620 the Internet
630 web server
640 content providers

These and other aspects of the present invention will become apparent upon reading the following detailed description in conjunction with the associated drawings.

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

All the above references and U.S. patents and applications are incorporated herein by reference. Aspects of the invention can be modified, if necessary, to employ the systems, functions and concepts of the various patents and applications described above to provide yet further embodiments of the invention.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

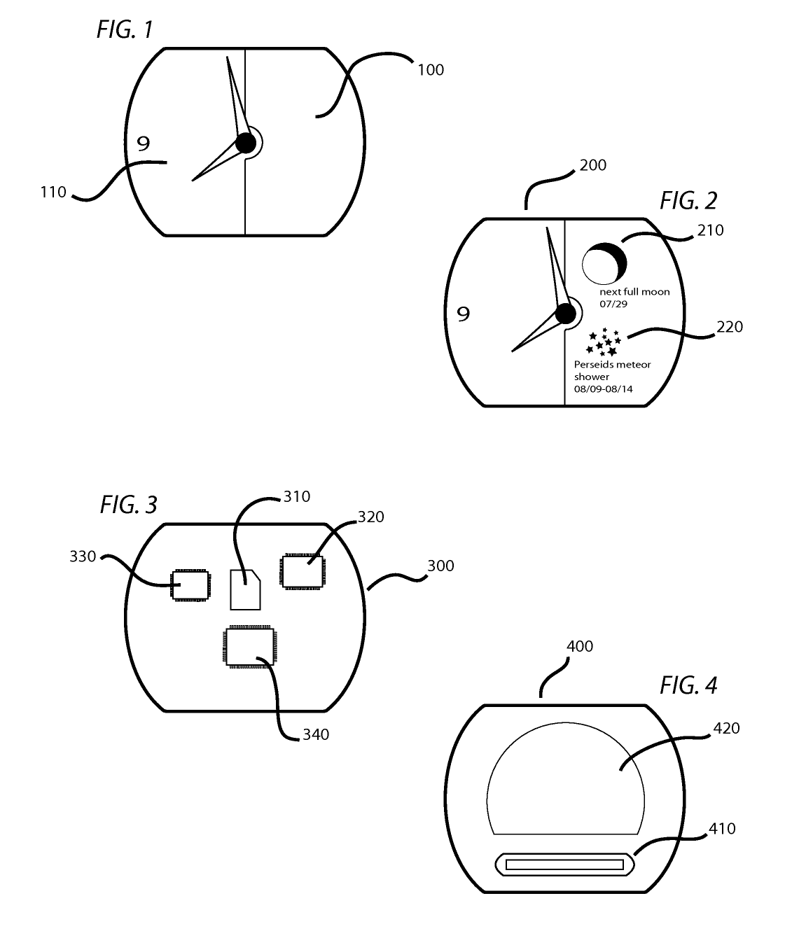

Referring to FIG. 1, a graphic display area 100 for a timepiece face is found next to a traditional timepiece face area 110. The content and design of the graphic display area 100 may be selected by a user, by use of a computer program or software, and is rendered within a graphic display area 100. The traditional timepiece face area may have traditional physical clock hands.

FIG. 1 also depicts a traditional timepiece face area 110 within or next to the graphic display area 100. The content and design of a traditional timepiece face area 110 is not intended to be editable by the user. The timepiece is preferably a wrist watch or pocket watch but it can also be a standalone or desktop device, or may be combined with the docking and charging station, as shown in FIG. 6, to form another self-supporting desktop configuration. Other types of secondary attachment mechanisms are also contemplated.

Referring to FIG. 2 a timepiece 200 shows a graphic representation of a moon phase 210, a celestial event, in the graphic display area. The same graphic display area also depicts a second celestial event, the Perseids meteor shower 220, and provides text information regarding the timing of a Perseids meteor shower. Graphical or textual descriptions of such events including celestial, meteorological events are sometimes referred to herein as event information. Such events, event information or complications may be chosen for display by the user by use of an interactive web based application. The display of meteorological information and events is also contemplated. Numerous events can be selected for display by actuating a proper sequence of user keys or by proper interaction with a touch sensitive membrane integrated into the timepiece crystal. In selecting the events to be displayed the user steps through a sequential series of geographical classifications. It is also contemplated that such information could be automatically generated by a GPS device, FIG. 3, 320 integrated into the timepiece. The user would then select from an array of celestial, and meteorological events provided within an interface. It is also contemplated that users could, by use of a software SDK provided, create and post events to share with other users. Once selected and loaded into the timepiece memory storage these events would be displayed, and information on them provided, relative to the geographical information also entered. The following table shows exemplary geographic and event classifications:

```
Continent
  Country
      Major City
          Postal Code
Celestial Events
  Sunrise/Sunset
  Solstice Dates
  Meteor Showers
      Perseids
      Haley's Comet
      Leonid
  Astronomical
      Crab Nebula (M1)
      Butterfly Cluster (M6)
      Triangulum Galaxy (M33)
Meteorological Events
  Current Daily Forecast
  Current 5 Day Forecast
  Ski Reports
  Surf Reports
```

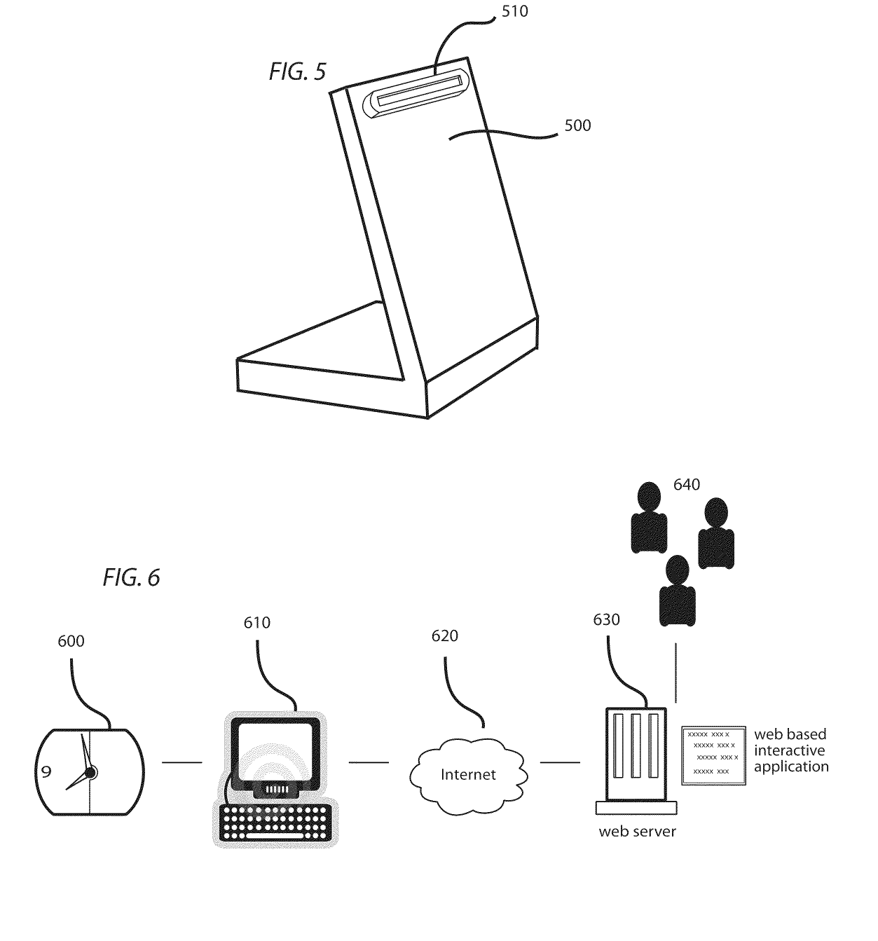

Referring to FIG. 3, a timepiece device 300 comprises a memory storage device 310 and a microprocessor 340. The timepiece device is also contemplated to include a GPS module 320, with an optional close proximity wireless communication module 330. Storage device 310 is flash memory microchip and may be permanently installed in the timepiece. However, it will be understood by one skilled in the art that other types of memory storage devices could be used inside the timepiece device. These could include various EEPROMs (electronic erasable programmable read-only memory) options and user accessible SD (secure digital) card type options as well. In a preferred embodiment up to 25 user chosen celestial, meteorological, or other events or complications may be stored for display. Larger memory options would of course allow for greater numbers of events to be stored. Microprocessor 340 can be any appropriate processing unit that is capable of performing the functionality described herein. A processor with a built in full graphic LCD-controller is preferred. GPS module 320 is capable of sending/receiving and decoding GPS information and communicating that information to the microprocessor 340. In this configuration the timepiece could calculate its geographical position without the user having to manually input such data. Close proximity wireless communication module 330 is capable of communicating with close proximity devices that also have that capability. It is contemplated that a companion docking and recharging station to the timepiece, described in FIG. 5, could be one such device. In another contemplated configuration, the timepiece could be used for proximity access control—such as the locking, unlocking and ignition functions of an automobile. A common close proximity communication technology is “Bluetooth” but it will be understood by those skilled in the art that other types of close proximity wireless communication could also be implemented.

Referring to FIG. 4 a timepiece device 400 includes a magnetic connector 410 for the purpose of recharging the timepiece battery. The magnetic connector fits with the connector area 510 of the docking and recharging station 500, shown in FIG. 5. The rechargeable battery 420 could be of integrated within a timepiece or be removable and replaceable. It is also contemplated that a connector could be additionally used for data transfer between the timepiece device and the docking and recharge station.

FIG. 5 illustrates a docking and recharge station 500 for the timepiece. In addition to providing a battery recharging function it is contemplated that this device could provide data communication between the timepiece and the user's personal computing and internet access device. This data communication may be achieved by hard contact or wireless technology. It is further contemplated that the docking and recharge station could provide additional functionality complementary to the timepiece device. This could include a larger display, additional timekeeping functions, such as an alarm clock, and/or storage and playback of digitally encoded media.

FIG. 6 illustrates a system for selecting and loading user selected content data into the timepiece device. The system includes content providers 640, one or more web servers 630, the Internet 620 or other network, a personal computing device 610, and a timepiece 600. Content providers 640 can be independent professionals in their fields of study such as astronomy, in house creative and technical personnel, or independent customers. It is also contemplated that original content could be independently created and sold online, via the companion interactive web site to the timepiece, directly to timepiece customers. The content, from the described sources, is loaded onto the web server 630. Web server 630 is a computer, or series of computers, or series of hard drives that store information which is made available to others.

In one embodiment, web server 630 is accessed by a user's computing device 610 in connection with the Internet 620. In one embodiment a user accesses the web server via a proprietary interactive web site. The user then chooses content for display on their timepiece. This content is then downloaded to the user's timepiece by means of physical connection or close proximity wireless connection, such as Bluetooth. The users can also manage the content, add, delete, store, and other actions, from their personal computing device by use of the interactive web site and connection to the web server, for display on their timepiece. It should be recognized that there are many paths, devices, protocols, and file transfer methods that can be utilized to transfer the content to the timepiece device. One contemplated method utilizes a wireless smartphone or personal digital communication device to access the interactive web site and provide an interface to the timepiece from which to change and manage the content for display.

The disclosed embodiments include but are not limited to the following items.

[Item 1] A timepiece comprising:
a) a timepiece case
b) an electrical memory apparatus used for the storing of celestial and meteorological event information and wherein such event information is targeted to the geographic location of the timepiece and wherein the electrical memory apparatus is contained within the timepiece case; and
c) a display screen attached to an upper and outer side of the timepiece case and wherein the display screen has a plurality of display areas, wherein such display areas include one or more software controlled graphical representations of celestial and meteorological event information and wherein a mechanical display area presents a representation of hours, minutes and seconds using clock hands and clock numbers.

[Item 2] The device of item 1 wherein event information presented upon one or more of the display areas further includes continent information, country information and city information.

[Item 3] The device of item 1 wherein the geographic location of the device is derived by use of a global positioning satellite apparatus contained within the timepiece case and wherein geographic information received from the global positioning satellite apparatus is used to calculate event information.

[Item 4] The device of item 3 wherein geographic location information is entered into the timepiece by use of a wireless apparatus within the timepiece and by use of a web interface located within a computer system and wherein the computer system is in communication with a webserver and the timepiece.

[Item 5] The device of item 1 wherein event information is calculated and the results of such calculation are stored within the electrical memory apparatus.

[Item 6] The device of item 1 wherein event information is entered into the electrical memory apparatus by use of an external web server connected to the timepiece by use of a wireless radio apparatus contained within the timepiece and in connection with the electrical memory apparatus.

[Item 7] The device of item 1 further comprising a microprocessor with the microprocessor connected to the display screen and with the microprocessor inputting display information to the display screen and with the microprocessor being programmed to sequentially display event information.

[Item 8] The device of item 7 within the microprocessor accepts user input and uses such input to alter the display of the event information.

[Item 9] A timepiece comprising:
a) a timepiece case;
b) a specialized microprocessor attached to the inside of the timepiece case and wherein the specialized microprocessor controls the display of a display screen attached to the timepiece case and wherein the microprocessor is specially programmed to change the display of event information in response to user input to the timepiece; and
c) wherein the specialized microprocessor causes the display screen to display event information and ancillary event information, wherein such ancillary event information comprises time of event, event duration and written information regarding the event.

[Item 10] The timepiece of item 9 wherein the specialized microprocessor updates the display of event information and ancillary event information on a periodic basis.

While certain aspects of the invention are presented below in certain claim forms, the inventor(s) contemplate the various aspects of the invention in any number of claim forms.

What is claimed is:

1. A timepiece comprising:
a) a timepiece case;
b) an electrical memory apparatus used for the storing of celestial and meteorological event information and wherein such event information is targeted to the geographic location of the timepiece and wherein the electrical memory apparatus is contained within the timepiece case; and
c) a display screen attached to an upper and outer side of the timepiece case and wherein the display screen has a plurality of display areas, wherein such display areas include one or more software controlled graphical representations of celestial and meteorological event information and wherein a mechanical display area presents a representation of hours, minutes and seconds using clock hands and clock numbers.

2. The device of clam 1 wherein event information presented upon one or more of the display areas further includes continent information, country information and city information.

3. The device of claim 1 wherein the geographic location of the device is derived by use of a global positioning satellite apparatus contained within the timepiece case and wherein geographic information received from the global positioning satellite apparatus is used to calculate event information.

4. The device of claim 3 wherein geographic location information is entered into the timepiece by use of a wireless apparatus within the timepiece and by use of a web interface located within a computer system and wherein the computer system is in communication with a web server and the timepiece.

5. The device of claim 1 wherein event information is calculated and the results of such calculation are stored within the electrical memory apparatus.

6. The device of claim 1 wherein event information is entered into the electrical memory apparatus by use of an external web server connected to the timepiece by use of a wireless radio apparatus contained within the timepiece and in connection with the electrical memory apparatus.

7. The device of claim 1 further comprising a microprocessor with the microprocessor connected to the display screen and with the microprocessor inputting display information to the display screen and with the microprocessor being programmed to sequentially display event information.

8. The device of claim 7 within the microprocessor accepts user input and uses such input to alter the display of the event information.

9. A timepiece comprising:
a) a timepiece case;
b) a specialized microprocessor attached to the inside of the timepiece case and wherein the specialized microprocessor controls the display of a display screen attached to the timepiece case and wherein the microprocessor is specially programmed to change the display of event information in response to user input to the timepiece; and
c) wherein the specialized microprocessor causes the display screen to display event information and ancillary event information, wherein such ancillary event information comprises time of event, event duration and written information regarding the event.

10. The timepiece of claim 9 wherein the specialized microprocessor updates the display of event information and ancillary event information on a periodic basis.
